(19) United States
(12) Patent Application Publication
(10) Pub. No.: US 2005/0003265 A1
(43) Pub. Date: Jan. 6, 2005

(54) Battery adapter

(75) Inventor: Chin-Long Chiang, Taipei Hsien (TW)

Correspondence Address: Cooper & Dunham LLP, 1185 Avenue of the Americas, New York, NY, 10036, US

(73) Assignee: O-Pine Electronic Co. Ltd.

(21) Appl. No.: 10/610,959

(22) Filed: Jul. 1, 2003

(51) Int. Cl. H01M 2/10; H01M 6/00; H01M 10/00

(52) U.S. Cl. 429/96; 429/100; 429/186

(57) ABSTRACT

A battery adapter has a hollow body having a conducting pole provided at a closed end, and a first coupling part formed at an open end. A bottom cover has a second coupling part formed at an upper end and engaged with the first coupling part. A seat is formed in the bottom cover, and a hole is defined through the seat. A conducting member, with a U-like cross section, is provided under the seat and exposed from a bottom end of the bottom cover. Therefore, received in the adapter, a small size battery can be used as a large size battery.

### BACKGROUND OF THE INVENTION

1. Field of the Invention

The present invention is related to a battery adapter, and more particularly to a device for transforming a small size battery into a large size one.

2. Description of Related Art

Batteries have standard models, such as D size, C size, AA size, AAA size etc, and many electric appliances are operated with the appropriate size batteries. For example, flashlights are often used with D size batteries. When a user has all the sizes of the batteries but the D size, the flashlight can not be used.

Therefore, the invention provides a battery adapter to mitigate and/or obviate the aforementioned problems.

### SUMMARY OF THE INVENTION

The main objective of the invention is to provide a battery adapter which can transform a small size battery into a large size one.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a battery adapter in accordance with the invention;

FIG. 2 is an exploded perspective view of the battery adapter and a small size battery;

FIG. 3 is a part cross sectional view of FIG. 2;

FIG. 4 is a part cross sectional view of a second embodiment of the invention;

FIG. 5 is a part cross sectional view of a third embodiment of the invention; and

FIG. 6 is a perspective view of a fourth embodiment of the invention.

### DETAILED DESCRIPTION OF THE PREFERRED EMBODIMENT

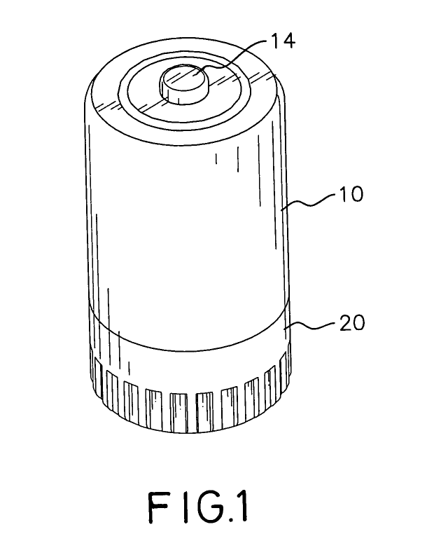

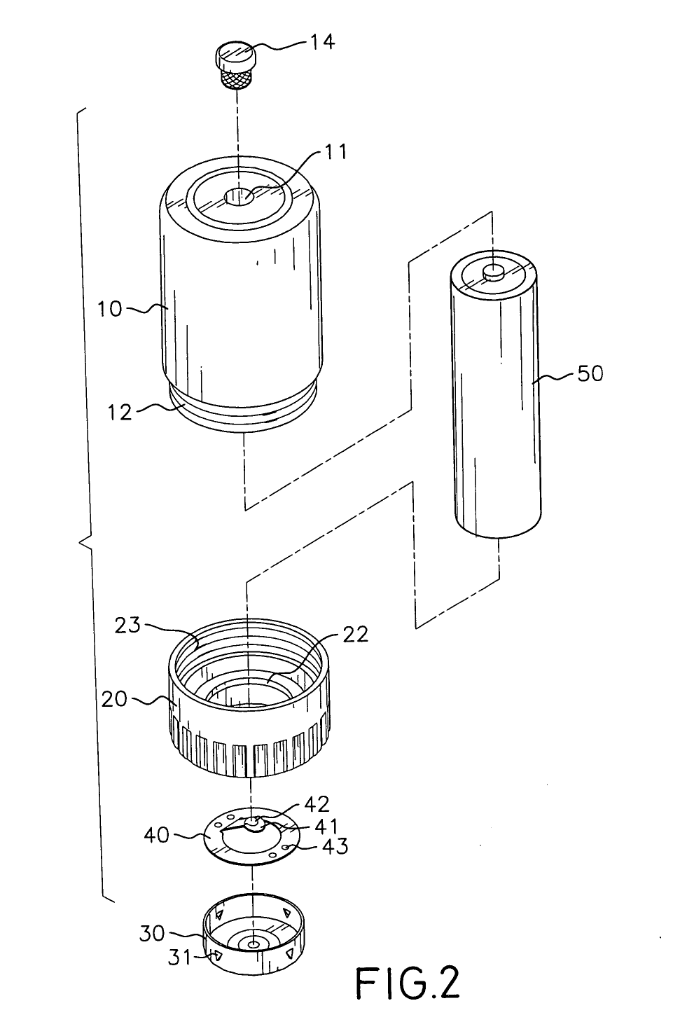

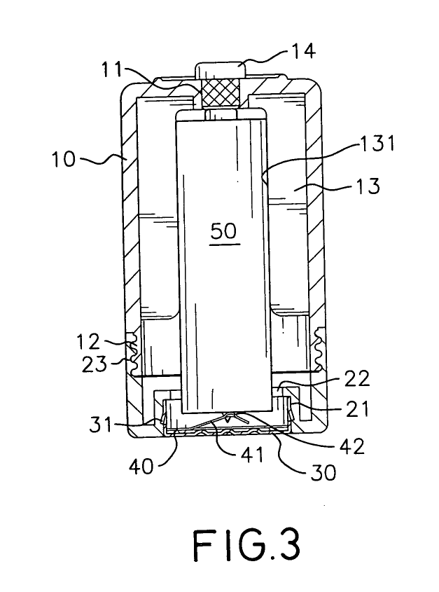

Referring to FIGS. 1-3, in accordance with the invention, a battery adapter is composed of a hollow body (10) and a bottom cover (20) detachably mounted together. A first coupling part (12) is formed at an open end of the hollow body (10), and an aperture (11) is defined through a closed end of the hollow body (10). A conducting pole (14) is installed in the aperture (11). An inner wall of the hollow body (10) has a plurality of ribs (13) formed thereon to define a space (131) for receiving a battery (50).

The bottom cover (20) has a second coupling part (23) formed at an upper end thereof for engaging with the first coupling part (12). In this embodiment, the first coupling part (12) is an internal thread, and the second coupling part (23) is an external thread. Thus, the hollow body (10) and the bottom cover (20) can be threadingly attached with each other. A seat (21) is formed in the bottom cover (20), and a hole (22) is defined through the seat (21).

A conducting member (30), of which a cross section is U-like, is mounted in the seat (21) and exposed from a bottom of the bottom cover (20). A plurality of pointed protrusions (31) is formed at an outer periphery of the conducting member (30) to position the conducting member (30) on an inner wall of the seat (21).

A ring (40) is provided in the conducting member (30), and has a plurality of connecting points (43) welded to the conducting member (30). The ring (40) further has a resilient leaf (41) extending therefrom towards the center of the ring (40). A lug (42) is formed on a free end of the resilient leaf (41).

When the battery (50) is received in the hollow body (10) and fastened by the ribs (13), a first electrode of the battery (50), such as the positive pole, is electrically connected with the conducting pole (14). After the bottom cover (20) is engaged with the body (10), a second electrode of the battery (50), such as the negative pole, is electrically connected with the resilient leaf (41). Therefore, the small size battery (50) can be used as a large size battery.

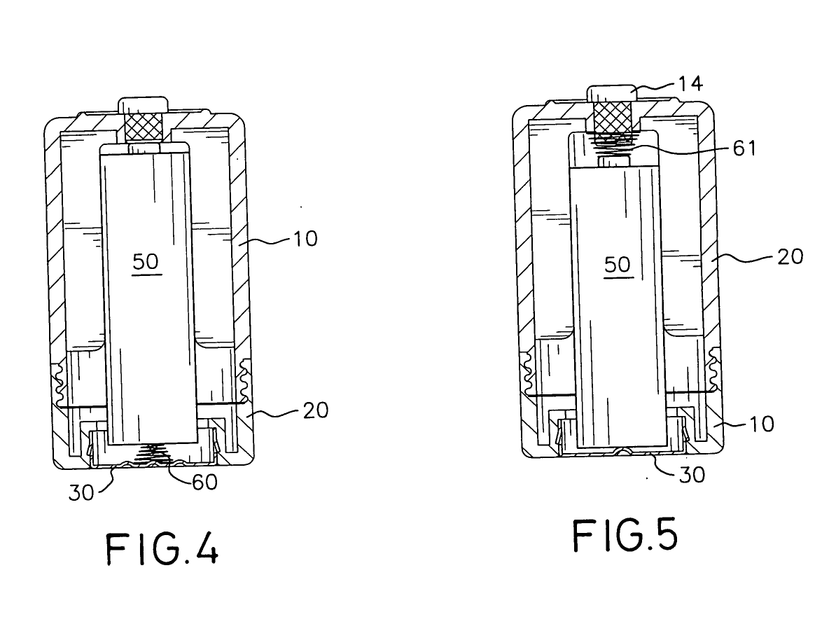

Referring to FIG. 4, in another embodiment of the invention, the ring (40) is replaced with a first resilient member (60) fixed in the conducting member (30).

Referring to FIG. 5, in a further embodiment of the invention, the conducting pole (14′) is provided with a second resilient member (61) at a lower end thereof. The first electrode of the battery (50) is electrically connected with the second resilient member (61), and the second electrode is electrically connected with the conducting member (30) directly.

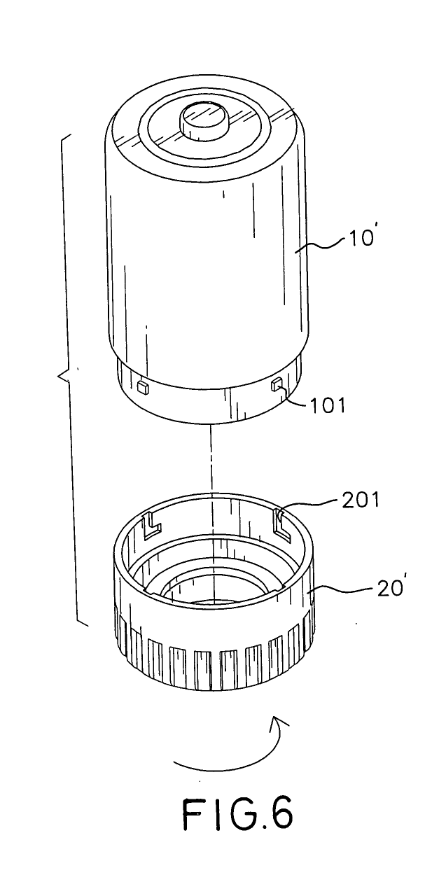

Referring to FIG. 6, in another embodiment, the body (10′) has a plurality of blocks (101) formed at an outer periphery of the open end thereof and respectively located in L-like slots (201) defined in the bottom covet (20′) for engaging the body (10′) and the bottom cover (20′).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A battery adapter comprising:
a hollow body (10) having a conducting pole (14) provided at a closed end thereof, and a first coupling part formed at an open end thereof;
a bottom cover (20) having a second coupling part formed at an upper end and engaged with the first coupling part, a seat (21) formed in the bottom cover (20), a hole (22) defined through the seat (21); and
a conducting member (30), with a U-like cross section, provided under the seat (21) and exposed from a bottom end of the bottom cover (20).

2. The battery adapter as claimed in claim 1 further comprising a ring (40) provided in the conducting member (30), the ring (40) having a resilient leaf (41) extending therefrom towards the center of the ring (40), and a lug (42) formed on a free end of the resilient leaf (41).

3. The battery adapter as claimed in claim 1 further comprising a resilient member (60) provided in the conducting member (30).

4. The battery adapter as claimed in claim 1 further comprising a resilient member (61) provided on a lower end of the conducting pole (14).

5. The battery adapter as claimed in claim 1, wherein the conducting member (30) has a plurality of pointed protrusions (31) formed at an outer periphery thereof and positioned in the seat (21).

6. The battery adapter as claimed in claim 2, wherein the conducting member (30) has a plurality of pointed protrusions (31) formed at an outer periphery thereof and positioned in the seat (21).

7. The battery adapter as claimed in claim 3, wherein the conducting member (30) has a plurality of pointed protrusions (31) formed at an outer periphery thereof and positioned in the seat (21).

8. The battery adapter as claimed in claim 4, wherein the conducting member (30) has a plurality of pointed protrusions (31) formed at an outer periphery thereof and positioned in the seat (21).

9. The battery adapter as claimed in claim 1, wherein the first coupling part of the body (10) is an internal thread, and the second coupling part of the bottom cover (20) is an external thread.

10. The battery adapter as claimed in claim 1, wherein the first coupling part of the body (10) is a plurality of blocks (101), and the second coupling part of the bottom cover (20) is a plurality of L-like slots (201).

11. The battery adapter as claimed in claim 1, wherein an inner wall of the body (10) has a plurality of ribs (13) formed thereon to define a space (131) for receiving a battery.
